(19) United States
(12) Patent Application Publication
(10) Pub. No.: US 2019/0379728 A1
(43) Pub. Date: Dec. 12, 2019

(54) CAPACITY SCALING FOR CLOUD BASED NETWORKING APPLICATIONS

(71) Applicant: Nokia Solutions and Networks Oy, Espoo (FI)

(72) Inventors: Jan Peter HELLSTROM, Helsinki (FI); Maria Sisko Leena KIVILAHTI-LOUHI, Espoo (FI); Jyri Kimmo Petteri PELTONEN, Oitmaki (FI)

(21) Appl. No.: 16/463,623

(22) PCT Filed: Nov. 23, 2016
(86) PCT No.: PCT/EP2016/078488

§ 371 Date: May 23, 2019

(51) Int. Cl. H04L 29/08; H04L 12/26; H04L 12/46

(52) U.S. Cl. CPC H04L 67/1002; H04L 12/4641; H04L 43/16

(57) ABSTRACT

A method and apparatus for scaling cloud computing re-sources e.g. virtual network function (VNF) components in a network comprises detecting a need for increasing or decreasing one or more of virtual network function (VNF) components, the VNF components being related to a VNF. In case of decreasing, one or more of the VNF components are selected for removal and the load of the selected one or more of the VNF components is relocated or rebalanced to a remainder of the VNF components and removal of the selected one or more of the VNF components is requested. In case of increasing, one or more VNF components to be deployed is determined, the additional one or more VNF components is requested, and after receiving a command to deploy the additional one or more VNF components the load of the VNF is rebalanced between the VNF components and the additional one or more VNF components.

### CROSS REFERENCE TO RELATED APPLICATIONS

This application claims priority to the PCT International Application No. PCT/EP2016/078488 having an international filing date of Nov. 23, 2016 and entitled “Capacity Scaling for Cloud Based Networking Applications,” which is hereby incorporated by reference in its entirety.

### TECHNICAL FIELD

The exemplary and non-limiting embodiments of the invention relate generally to communications. Embodiments of the invention relate especially to cloud computing and the life cycle management of virtualized network applications.

### BACKGROUND

In a wireless network, resource allocation may play a critical part in providing functionality for user devices. One way to reduce limitations of physical hardware may be to provide virtualized network functions which may utilize resources from one or more physical entities of the wireless networks. The physical entities may be located in a cloud network.

In order to achieve the benefits of cloud based networking, legacy software based networking product designs as a physical network function (PNF) may be converted to a virtualized network function (VNF) which are realised using cloud based computing as virtual resources (VM).

Unlike with legacy physical network functions, virtualized network function in cloud do not need to have fixed dimensioned processing resources. The virtualized network function located in the cloud are supposed to use processing resources adaptive to the offered work load. Therefore dynamic load-adaptive processing resource i.e. virtualized network function component scaling principle is recommended. Legacy physical network functions have not typically supported hitless capacity scaling modifications (upgrades/downgrades) for runtime systems. It has been allowed by network operators to cause temporary, short duration network service outages while performing capacity modifications. Therefore plain virtualization of physical network functions into virtualized network functions will inevitably result network service discontinuity and service disruption. This is not expected anymore in cloud based realisations.

### BRIEF DESCRIPTION

According to an aspect of the present invention, there is provided methods according to claims 1 and 6. According to an aspect of the present invention, there is provided apparatuses according to claims 9 and 14.

Examples of implementations are set forth in more detail in the accompanying drawings and the description below. Other features will be apparent from the description and drawings, and from the claims.

### BRIEF DESCRIPTION OF THE DRAWINGS

In the following the invention will be described in greater detail by means of preferred embodiments with reference to the attached drawings, in which

FIG. 1 illustrates an example wireless communication system to which embodiments of the invention may be applied;

FIGS. 2 and 3 illustrate example of virtualized network functions to which embodiments of the invention may be applied;

FIG. 4 is a flowchart illustrating an example embodiment;

FIGS. 5A, 5B and 5C illustrate examples of balancing pre- and post-work performed by a virtual network function;

FIGS. 6A to 6D, are flowcharts illustrating some example embodiments of the invention;

FIGS. 7A and 7B are flowcharts illustrating some example embodiments of the invention; and

FIG. 8 illustrates an example of an apparatus of an embodiment.

### DETAILED DESCRIPTION OF SOME EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Embodiments described may be implemented in any Information technology (IT) system supporting required functionalities. In following, as an example, embodiments of the invention are described in connection with a radio system, such as in at least one of the following: Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), and/or LTE-Advanced.

The embodiments are not, however, restricted to the system given as an example but a person skilled in the art may apply the solution to other systems provided with necessary properties. Another example of a suitable communications system is the 5G concept. 5G is likely to use multiple input-multiple output (MIMO) techniques (including MIMO antennas), many more base stations or nodes than the LTE (a so-called small cell concept), including macro sites operating in cooperation with smaller stations and perhaps also employing a variety of radio technologies for better coverage and enhanced data rates. 5G will likely be comprised of more than one radio access technology (RAT), each optimized for certain use cases and/or spectrum. 5G mobile communications will have a wider range of use cases and related applications including video streaming, augmented reality, different ways of data sharing and various forms of machine type applications, including vehicular safety, different sensors and real-time control. 5G is expected to have multiple radio interfaces, namely below 6 GHz, cmWave and mmWave, and also it may be integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz—cmWave, below 6 GHz—cmWave—mmWave).

One of the concepts considered to be used in 5G networks is network slicing in which multiple independent and dedicated virtual sub-networks (networks instances) may be created within the same infrastructure to run services that have different requirements on latency, reliability, throughput and mobility. It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or cloud data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE. Some of the functions of the LTE may even be nonexistent in the 5G system. Some other technology advancements probably to be used are Software-Defined Networking (SDN), Big Data, and all-IP, which may change the way networks are being constructed and managed.

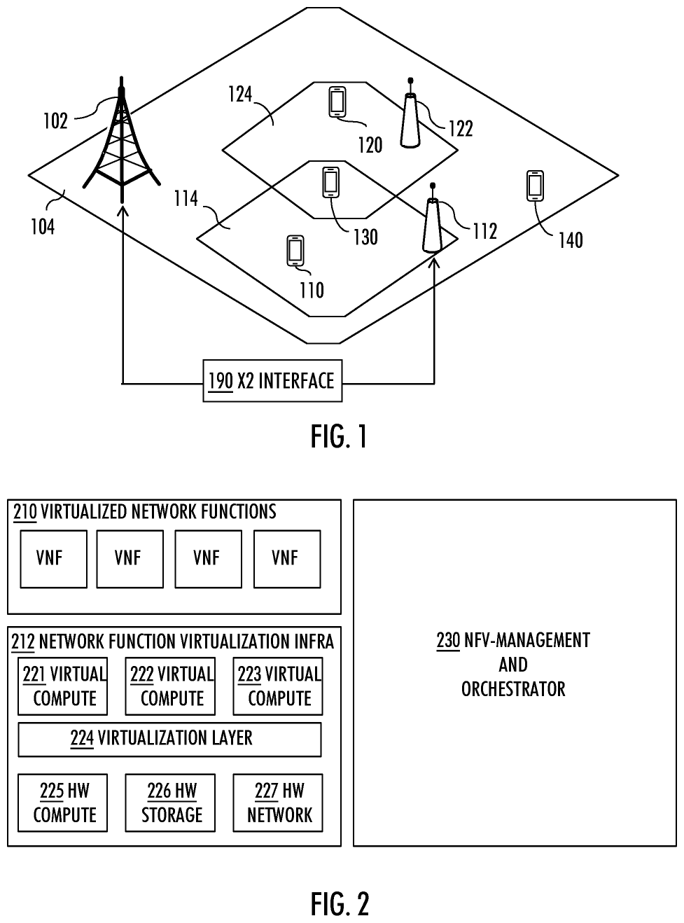

FIG. 1 illustrates example of a radio system (also referred to as a cellular communication system or cellular system) to which embodiments of the invention may be applied. Radio communication networks or wireless communication networks, such as the Wireless Local Area Network (WLAN, or WiFi) the Long Term Evolution (LTE), the LTE-Advanced (LTE-A) of the 3rd Generation Partnership Project (3GPP), or the predicted future 5G solutions, are typically composed of at least one network element, such as a network element 102, providing a cell 104. In the example of FIG. 1, cells 104, 114, 124 may be shown. The cell 114 may be provided by a network element 112, and the cell 124 may be provided by a network element 122, for example. The cell 104 may be provided by the network element 102. It is, however, possible that a network element of the radio system may provide more than one cell. Thus, for example, the network element 102 may provide the cell 104, the cell 114, and/or the cell 124. In general, the system may comprise one or more network elements (similar to those described with reference to FIG. 1), wherein each network element provides one or more cells providing service to one or more terminal devices in the cells.

Each cell of the radio communication network may be, e.g., a macro cell, a micro cell, a femto, or a pico-cell, for example, meaning that there may be one or more of each of the described cells. Each network element of the radio communication network, such as the network elements 102, 112, 122, may be an evolved Node B (eNB) as in the LTE and LTE-A, a radio network controller (RNC) as in the UMTS, a base station controller (BSC) as in the GSM/GERAN, Access Point (AP), or any other apparatus capable of controlling radio communication and managing radio resources within a cell. That is, there may be one or more of each of the described apparatuses or entities. To give couple of examples, the network element 102 may be an eNB, for example. The network element 112 may also be an eNB. For example, network element 102 may provide a macro cell and the network element 112 may provide a micro cell.

For 5G solutions, the implementation may be similar to LTE-A, as described above. The network elements 102, 112, 122 may be base station(s) or a small base station(s), for example. In the case of multiple eNBs in the communication network, the eNBs may be connected to each other with an X2 interface 190 as specified in the LTE. Example of this may be shown in FIG. 1, wherein the network element 112 may be shown to be connected to the network element 102 via the X2 interface 190. Other communication methods between the network elements may also be possible. For example, APs of WLAN system may communicate with each other. At least some of the network elements 102, 112, 122 may be further connected via an S1 interface to an evolved packet core, more specifically to a mobility management entity (MME) and to a system architecture evolution gateway (SAE-GW). So in general, the network elements of FIG. 1 may be communicatively connected (wireless and/or wired) to each other using one or more circuitries. The X2 interface 190 is one example of how to realize such communication.

The cells 114, 124 may also be referred to as sub-cells or local area cells, for example. The network elements 112, 122 may be referred to as sub-network elements or local area access nodes, for example. The cell 104 may be referred also to as a macro cell, for example. The network element 102 may be referred to as a macro network element, for example. In an embodiment, the local area access nodes are network elements similar to the network element 102. Thus, for example, the local area access node 112 may be an eNB or a macro eNB.

The cells 104, 114, 124 may provide service for at least one terminal device 110, 120, 130, 140, wherein the at least one terminal device 110, 120, 130, 140 may be located within or comprised in at least one of the cells 104, 114, 124. The at least one terminal device 110, 120, 130, 140 may communicate with the network elements 102, 112, 122 using communication link(s), which may be understood as communication link(s) for end-to-end communication, wherein source device transmits data to the destination device. It needs to be understood that the cells 104, 114, 124 may provide service for a certain area, and thus the at least one terminal device 110, 120, 130, 140 may need to be within said area in order to be able to use said service (horizontally and/or vertically). For example, a third terminal device 130 may be able to use service provided by the cells 104, 114, 124. On the other hand, fourth terminal device 140 may be able to use only service of the cell 104, for example.

The cells 104, 114, 124 may be at least partially overlapping with each other. Thus, the at least one terminal device 110, 120, 130, 140 may be enable to use service of more than one cell at a time. For example, the sub-cells 114, 124 may be small cells that are associated with the macro cell 104. This may mean that the network element 102 (e.g. macro network element 102) may at least partially control the network elements 112, 122 (e.g. local area access nodes). For example, the macro network element 102 may cause the local area access nodes 112, 122 to transmit data to the at least one terminal device 110, 120, 130, 140. It may also be possible to receive data, by the network element 102, from the at least one terminal device 110, 120, 130, 140 via the network elements 112, 122. To further explain the scenario, the cells 114, 124 may be at least partially within the cell 104.

In an embodiment, the at least one terminal device 110, 120, 130, 140 is able to communicate with other similar devices via the network element 102 and/or the local area access nodes 112, 122. For example, a first terminal device 110 may transmit data via the network element 102 to a third terminal device 130. The other devices may be within the cell 104 and/or may be within other cells provided by other network elements. The at least one terminal device 110, 120, 130, 140 may be stationary or on the move.

The at least one terminal device 110, 120, 130, 140 may comprise mobile phones, smart phones, tablet computers, laptops and other devices used for user communication with the radio communication network. These devices may provide further functionality compared to the MTC schema, such as communication link for voice, video and/or data transfer. However, it needs to be understood that the at least one terminal device 110, 120, 130, 140 may also comprise Machine Type Communication (MTC) capable devices, such as sensor devices, e.g. providing position, acceleration and/or temperature information to name a few examples.

The radio system of FIG. 1 may be configured to provide one or more VNFs 210 as shown in the example of FIG. 2. This may mean that at least some of the functions provided by the radio system are virtualized. It may be that some functions are provided directly by physical entities and some are virtualized or that all network functions are virtualized. Examples of VNFs may comprise a firewall function, antivirus function, video optimizer function, parental control function, router function, Internet Protocol Security (IPS), Radio Network Controller (RNC), or Evolved Packet Core (EPC), to name only a few examples. In general, if for example a router function is normally provided by physical entity, it may be virtualized and thus the router function may become a VNF, i.e. router VNF.

Referring to FIG. 2, the virtualization may work such that physical hardware resources 225-227 comprising one or more hardware computing entities (e.g. processors, servers), one or more hardware storages (e.g. databases) and one or more hardware network resources (e.g. radio interfaces, wiring) are virtualized via virtualization layer 224. The virtualization layer 224 may be responsible of abstracting the physical resources provided by the hardware layer 225-227 into virtual resources 221-223. The VNFs 210 may utilize the virtual resources 221-223 to provide needed functionalities. Virtualization provides benefits, for example, as the virtual resources 221-223 may be scaled using the hardware resources 225-227. For example, more hardware resources may be dynamically allocated for the virtual entities if a need arises. Similarly, hardware resources may be used for some other purpose when, for example, network load is lower.

The virtualization of network functions may also utilize a specific NFV management and orchestration entity 230 that may be responsible for controlling the VNFs 210. For example, the NFV management and orchestration entity 230 may create VNFs or control how different VNFs work. Further the NFV management and orchestration entity 230 may control the virtualization of the hardware resources 225-227 into the virtual resources 221-223 via the virtualization layer 224.

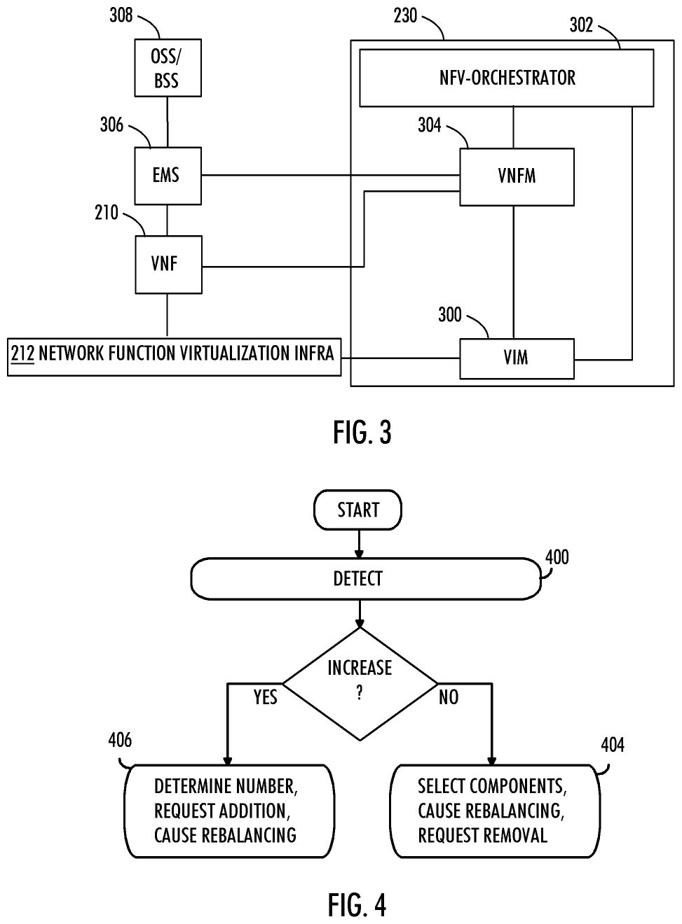

FIG. 3 illustrates a simplified example of the NFV management and orchestration entity 230. The entity may comprise a Virtualised Infrastructure Manager (VIM) 300. The VIM controls and manages NFVI 212 resources typically within one operator's infrastructure.

The entity may comprise an NFV Orchestrator (NFVO) 302, responsible for the orchestration of NFVI resources across multiple VIMs and lifecycle management of Network Services and other management related tasks.

The NFV management and orchestration entity further comprises a Virtual Network Function Manager (VNFM) 304 responsible for lifecycle management of VNF instances. Each VNF instance has an associated VNF Manager. A VNF manager may be assigned the management of a single VNF instance, or the management of multiple VNF instances of the same type or of different types.

The system may also comprise other blocks such as Element management EMS 306 which may have following tasks: configuration and fault management for the network functions provided by the VNF, security management for the VNF functions and collecting performance measurement results for the functions provided by the VNF.

Further, the system may comprise Operations Support System/Business Support System (OSS/BSS) block 308, which relates to combination of network operators operations and business support functions.

A particular VNF scaling aspect (capacity vector) requires to define an association with one or more independently scalable resource pools or dimensions. Subsequently, NFV should support scaling of resources so that resources may be optimally used and keep the performance at a required level. The performance for the system is typically monitored by so called Key Performance Indicators (KPI). A dynamic load-adaptive solution for managing resources is needed. A virtualized network function VNF typically comprises virtualized network function components (VNFC). A virtualized network function component is a software component performing a given task. A VNF may comprise a varying number of components depending on the load of the VNF. Thus, typically scaling the VNF is realised by adding or removing the number of VNFCs associated with the VNF.

European Telecommunications Standards Institute (ETSI) which coordinates the work on NFV, has defined three VNF capacity scaling models: scaling on management request, on-demand scaling and auto-scaling. In scaling on management request, the initiative for scaling originates from the network operator, NFVO or OSS/BSS. In on-demand scaling, the initiative for scaling originates from VNF instance itself or its EM which monitor the state of a VNF instance and trigger a scaling operation.

In auto scaling, VNF Manager (VNFM) may obtain physical processing resource (CPU time, memory) utilization based metrics from the virtual infra structure. Based on VNF specific scaling descriptors (information elements for triggering and controlling the VNFC instance scaling) VNFM carries out the VNFC instance add and removal with VNF.

The problem with the VNFM initiated VNFC scaling is that VNFM is not natively aware of any detailed information on those conditions that matters for preserving the Key Performance Indicator (KPI) under presently offered workload and present VNFC instance present resource utilization. There is no direct and precise correlation between present physical resource utilization and present KPI level of VNFs. The KPI measurements are based on diverse set of performance counters that are in runtime system collected by the VNF application.

The KPI data is delivered from the VNF 210 to EMS 306, but since it represents status of VNF's historical performance e.g. series of hourly collected KPI status, the network operator cannot use it as reliable input for VNFs present KPI status.

There is a need for a uniform and simple way to support different scaling models for complex VNF applications by a single solution that allows preserve the level Key Performance Indicators (KPI)such as level of network accessibility, retainability and throughput during the VDU/VNFC instance scaling operation.

The management of VNFC instance scaling can be simplified by adding more intelligence to VNF itself to carry out VNFC instance scaling control autonomously and gracefully. In an embodiment, the VNF's main scaling functionalities may be as monitoring and analysis, scaling resolution, selection of VNFC instances subject to scaling and graceful pre-work and post-work related to scaling operation.

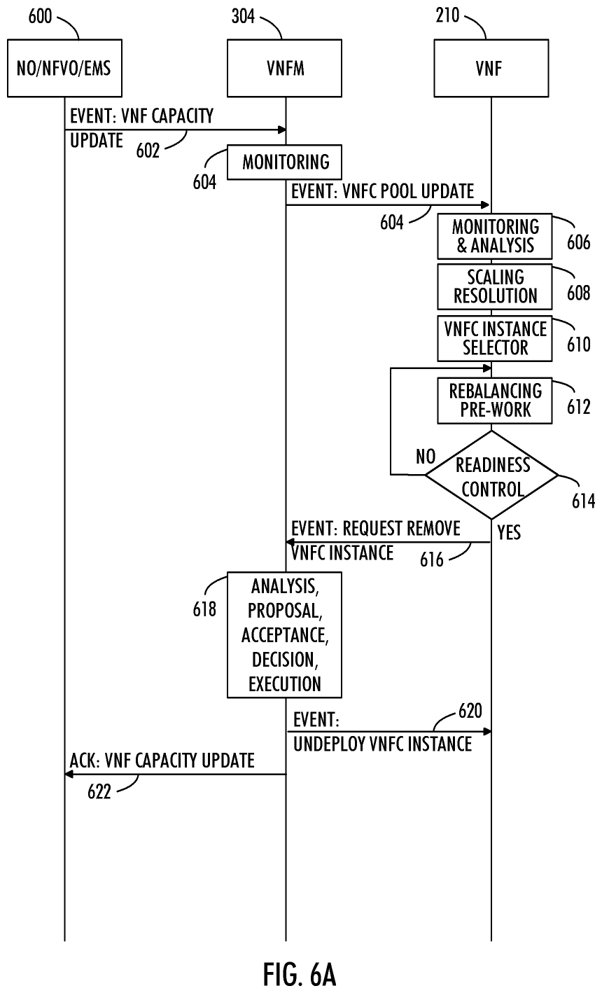

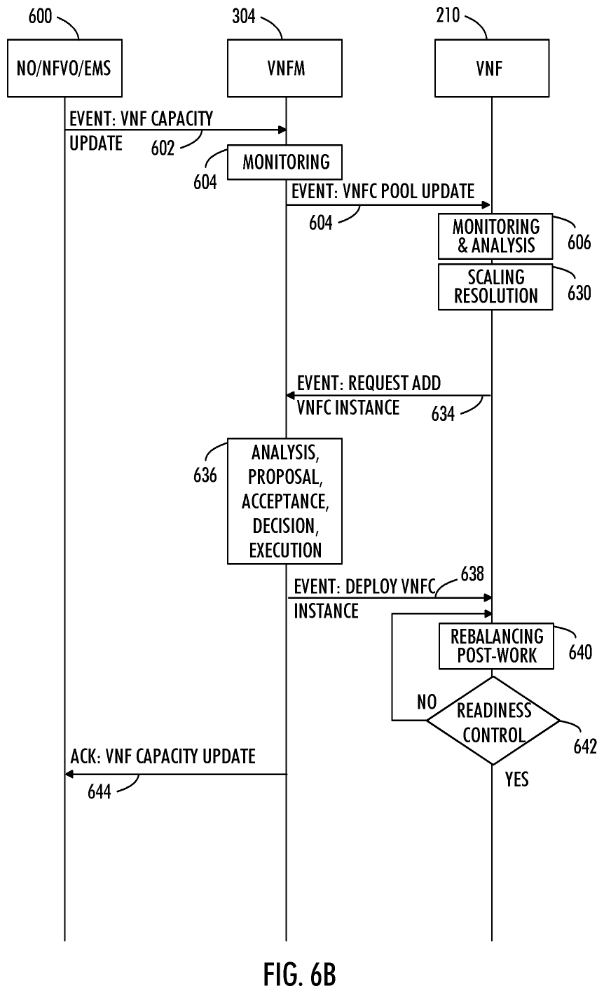

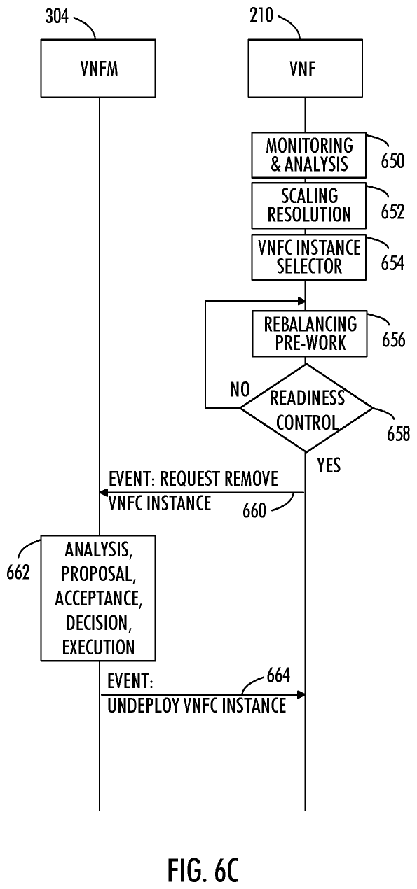

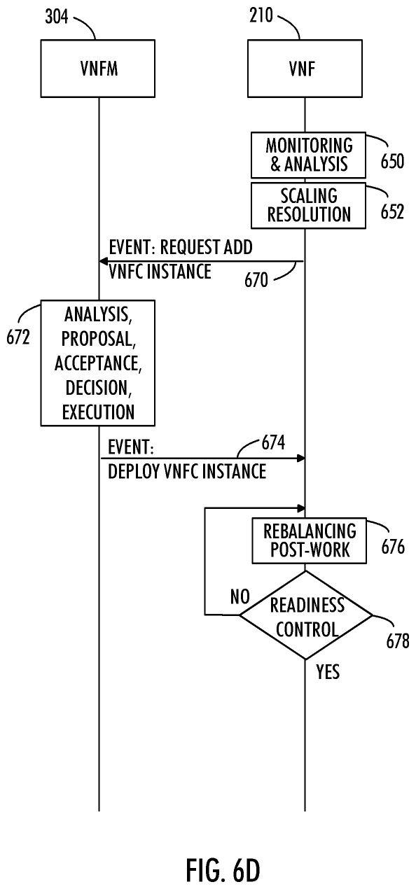

In an embodiment, the VNFM is configured to implement simple scaling event forwarding and execution functionality where most of the processing within VNFM event processing pipeline can be stateless and triggered either by external or VNFM internal events. When no VNF user (such as a network operator) manual acceptance needed is for scaling proposals, the external processing may be done in a run-to-completion manner that will generate a particular new external or VNFM internal event. A typical VNFM can consist of the following functionalities: monitoring, analysis, scaling proposal, acceptance of scaling proposal, decision and execution. Actions performed by these functions will be explained in connection with FIGS. 6A and 6B.

It may be noted that VNFM may also be able to perform handling for controlling in parallel scaling operations that may have different initiators (network operator, NFVO, EM or VNF itself).

In an embodiment, the VNF interactions with VNFM is based on INPUT EVENT and OUTPUT EVENT handing (from VNF's view point). The naming convention (input, output, external) is determined from VNF point of view.

Non-VNF specific external events include

EXTERNAL EVENT (1): network operator, NFVO or element manager initiates VNF resource scaling request to VNFM. Applied information elements of the event are identity of the VNF and new resource amount.

The external event (1) is visible only to VNFM and is referred to clarify the VNF external initiation of VNF capacity scaling by network operator, NFVO or EM through.

Event specific to certain ETSI scaling model:

INPUT EVENT (2): a VNFM initiated VNFC pool update with VNF. Applied information elements of the event are identity of the VNF and new amount. This INPUT EVENT may be used in connection with two of the ETSI specified scaling models: scaling on management request that may be forcefully initiated by network operator manually, by orchestrator or by VNF element manager (EMS) and Auto-scaling initiated by VNFM.

When the initiation of capacity scaling comes from VNFM, possibly dictated by network operator or management, this event may be used as VNFC pool update. The pool update may concern the VNFC pool size update (contraction, expansion) or an explicit request for removing a particular VNFC instance or adding a VNFC instance.

OUTPUT and INPUT events common to all ETSI scaling models include:

OUTPUT EVENT (3) a VNF initiated request for immediate VNFC instance(s) removal or addition to VNFM. Applied information elements of the event are identity, amount. However, identity element is not applicable with VNFC instance add scenario.

INPUT EVENT (4): a VNFM initiated undeployment (in other words removal) or deployment for specific VNFC instance(s) with VNF. Applied information elements of the event are identity and amount.

It may be noted that only these two (3,) and (4) simple event based interactions are needed for a VNF initiated on-demand scaling by ETSI. The use of these common events always allows VNF perform pre-work before the actual request for VNFC instance removal is forwarded to VNFM.

Since VNF itself possesses all up to date information on VNF's offered present workload and its present VNFC instance resource utilization, it has full control for creating such favorable pre-conditions and post-conditions that are needed in graceful VNFC instance removal and adding without causing a drop in KPI. The pre-work and post-work functionality of VNF related to scaling operation is discussed below.

FIG. 4 is a flowchart illustrating an example embodiment of the operation of the VNF. The flowchart shows examples of general operation of VNF, and more detailed description related to different scaling models are discussed below.

In step 400, VNF detects a need for increasing or decreasing the VNC capacity, i.e. one or more of VNF components realised with computing resources, the VNF components being related to the VNF.

In connection with scaling on management request and auto scaling, the detecting comprises receiving a message comprising a request to increase or decrease the VNF capacity.

In case of on-demand scaling, the detecting comprises monitoring the load of the VNF, observing that there may be a need to increase or decrease the VNF capacity.

In case of decreasing 404, the VNF is configured to select one or more of the VNF components for removal and cause relocation or rebalancing of the load of the selected one or more of the VNF components to a remainder of the VNF components and request from the VNFM removal of the selected one or more of the VNF components when the relocation and/or rebalancing is ready.

In case of increasing 406, the VNF is configured to determine additional one or more VNF components to be deployed, request from the VNFM the additional one or more VNF components, and upon receiving a message (for example a command to deploy the additional one or more VNF components) cause rebalancing of load of the VNF between the VNF components and the additional one or more VNF components.

The VNF itself thus acts as the initiator of the scaling by monitoring the load of the VNF, observing that the load decreases below a first predetermined threshold and determining on the basis of observation that there may be a need to decrease the number of VNF components. After determination, VNF is configured to select one or more VNF Components for removal and initiate rebalancing of the load of the selected components to remaining components. When VNF further observes that the load crosses a second predetermined threshold it may request removal of the component when the rebalancing is ready. The VNF may also observe that the load increases above a fourth predetermined threshold in which case there is a need to increase the number of VNF components.

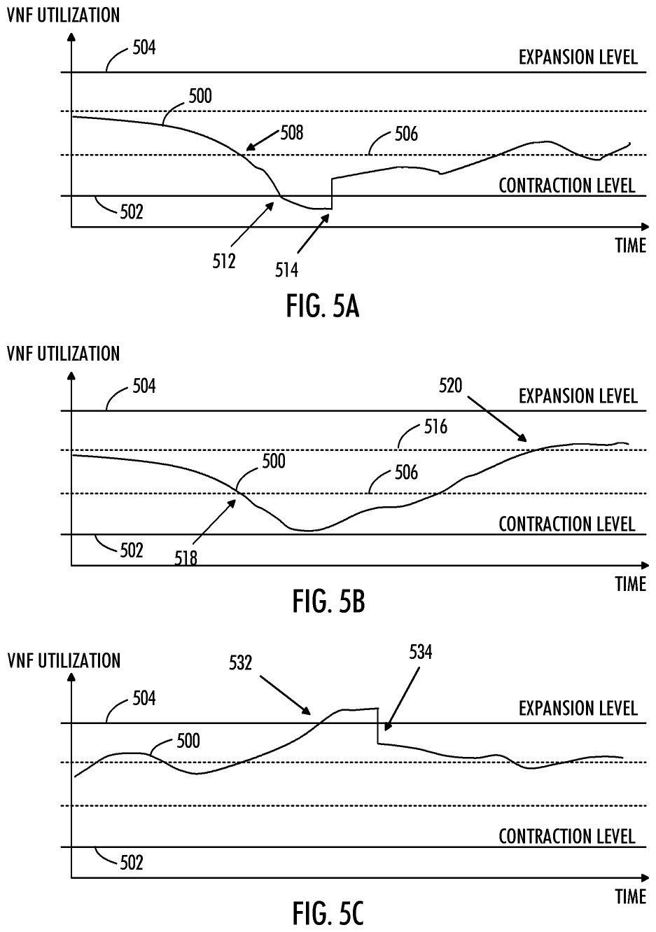

One of the aspects of scaling where VNF plays an active role is the ability of VNF to perform scaling associated pre-work and post-work. Their purpose with intelligent scaling is described next. FIGS. 5A, 5B and 5C illustrate examples of balancing pre-work and post-work performed by VNF in connection with scaling operations.

When the network operator intends maximize resource utilization by matching the processing resource (VNFC) count with the offered load optimally by means of dynamic VNFC scaling in runtime, it also wishes minimize the KPI drop and degradation with end user perception of service level. To satisfy the both two somewhat contradicting objectives the intelligent contraction of VNFC resources is paramount. The intelligent contraction of processing resources has two key characteristics that are depicted in FIGS. 5A and 5B.

FIG. 5A illustrates an example of balancing pre-work in connection with scaling operation that is concluded. Thus the figure presents a VNFC contraction scenario that will eventually proceed to VNFC contraction i.e. removal.

On x-axis is time and on y-axis is the VNF load or VNF utilization. Thus the graph illustrates the load 500 as a function of time. In an embodiment, the VNF is configured to utilize threshold values of triggers when monitoring the load 500. The contraction level 502 denotes the value of the load when contraction is set to begin, i.e. the number of VNF components is reduced. The expansion level 504 denotes the value of the load when expansion is set to begin, i.e. the number of VNF components is increased.

In an embodiment, an additional predefined threshold 506 is applied in the following manner.

In Monitoring and Analysis-operation, VNF is configured to detect declining load trend that will cross the predefined threshold 506 at a point 508. The load value enters the pre-work level where pre-work for possible future contraction is started.

Once the pre-work threshold 506 is crossed the VNF starts preparing for future contraction by selecting one or more VNF Components and rebalancing the present workload of the selected VNFC(s) to other VNFCs of VNF. The load is naturally balanced to those VNFCs that will remain in the VNF configuration after contraction. In this example, pre-work actually tests that the contraction operation can be concluded without service disrupt and immediate expansion operation (i.e. scaling oscillation).

When the load reaches the contraction level 502 at point 512, the contraction is started in case the pre-work is also concluded by this point and the contraction won't cause crossing of expansion level 504. This may mean sending a request to VNFM to release one or more VNFCs. At point 514 the contraction has been completed. As the number of VNFCs is reduced, the load increases.

In the above example the VNFC contraction proceeded to its completion. It is however possible that after the contraction pre-work started the declining of the load 500 stops and may turn to an ascending trend. FIG. 5B illustrates such an example. In an embodiment, the pre-work may be interrupted if the load does not fall below the contraction level 502. In the example of FIG. 5B, the load first crosses the contraction level 502 at point 518. The pre-work, i.e. selecting a VNFC and rebalancing its load to other VNFCs starts. However, in this example the load starts ascending prior crossing the contraction level 502. When the load crosses a given stop pre-work level 516, the pre-work is stopped and no VNFCs are released. Thus, no request to VNFM to release one or more VNFCs (OUTPUT EVENT (3)) is sent.

This feature is useful since it prevents unnecessary VNFC resource scaling to occur in situations where the nature of VNF loads is very fluctuating.

The straightest forward scaling operation is VNFC expansion. A VNF may request VNFC add ((OUTPUT EVENT (3)) from VNFM to be able to match to increasing offered load.

FIG. 5C illustrates an example of increasing load. The graph of FIG. 5C presents a scenario that will result the addition of new (empty) VNFC to resource pool of VNF. In the example VNF will detect ascending load trend in the load 500 and the load will cross a predefined threshold 504 for starting VNFC capacity expansion at point 532.

Once the VNF utilization threshold for triggering the expansion gets crossed and related messaging with VNFM have been processed by VNF together with VNFM at point 534, VNF may start as post-work rebalancing of the present work load and also balance new offered load and present load from prior VNFCs to the newly added empty VNFC.

There are various ways of selecting the pre-work activation and cancellation threshold values 506, 516.

In an embodiment, pre-work can be performed as a continuous function making a selected VNFC more permanent candidate for removal. Thus it is not required that it shares the same utilization as the other VNFCs in same resource pool. As it is possible that a declining load trend may change before the conditions for VNFC removal are met, a cancellation threshold is needed if ascending load trend resumes.

In an embodiment, pre-work threshold may be selected such that the crossing of pre-work threshold still gives time to rebalance the present load of a selected VNFC and shut down or relocate its services gracefully to other VNFCs before the declining load meets the contraction level.

In an embodiment, it does not matter which condition, pre-work completed or contraction allowed by utilization is met first since both conditions shall be met before required communication (OUTPUT EVENT (3)) with VNFM.

In an embodiment, the pre-work completion is a mandatory condition for VNFC removal. Thus it may automatically tested whether all the service load in the VNFC subject of removal can be adopted by other remaining VNFCs—before the VNFC is actually removed.

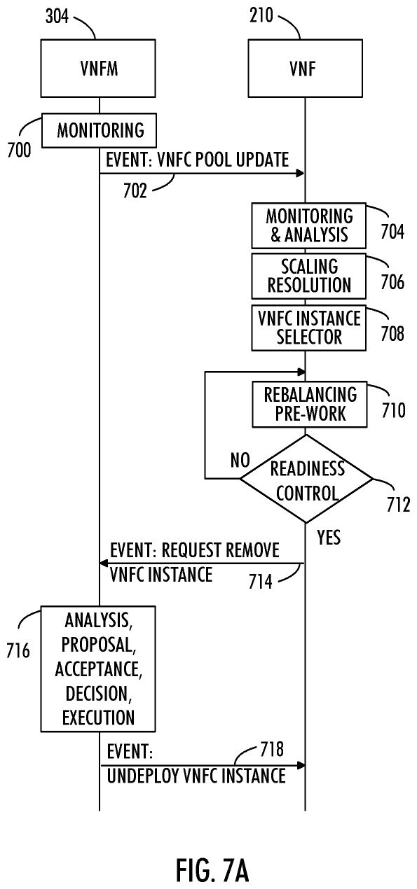

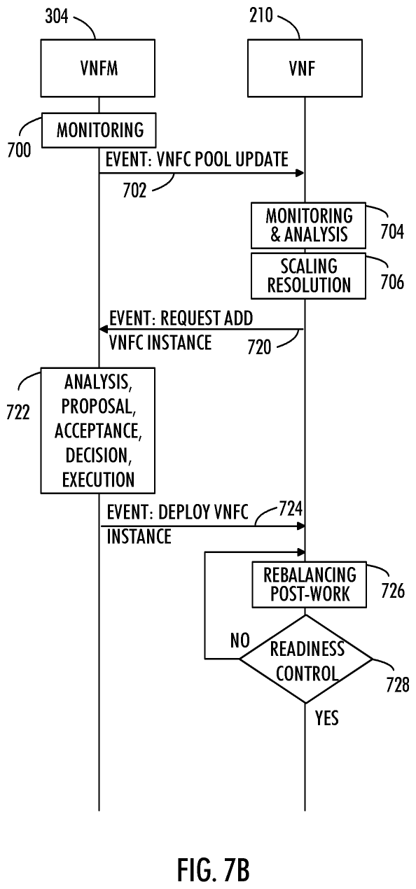

FIGS. 6A to 6D, 7A and 7B are flowcharts illustrating some example embodiments of the invention. The flowcharts shows examples of general operation of capacity expansion and contraction (as scale-to) or scale-in and scale-out of VNFC resources in connection with different scaling models defined by ETSI.

FIG. 6A illustrates an example of VNFC capacity contraction in connection with the scaling on management request.

The scaling is initiated by the network operator, NFVO or element management 600. The management issues a scaling request 602 to VNFM 304.

Monitoring function 604 of VNFM is configured to decode the management request and forward 604 it to VNF is as an INPUT EVENT (2) encoded as VNFC pool size update. The message comprises the new amount of pool size as an information element.

In another example embodiment, the scaling request 602 is transmitted by the network operator, NFVO or element management 600 directly to the VNF.

The VNF receives the message and the monitoring and analysis function 606 of the VNF decodes the VNFC pool update and forwards it as an INTERNAL EVENT to scaling resolution function 608 of the VNF. The scaling resolution function resolves the new pool size by comparing the new amount with the current amount of VNFCs. The output of the scaling resolution function is in this case VNFC removal that is next notified to VNFC selector function which is invoked as a result.

The VNFC selector function 610 is configured to make a decision which individual VNFC (or VNFCs) at a time provides most favourable conditions for being the subject of removal. When the VNFC is selected a notification of the selected VNFC instance is forwarded as INTERNAL EVENT to rebalancing pre-work function 612. The pre-work has been described in more detailed above. It may be noted that the VNFC selection phase is conditional and may be bypassed if the management has itself explicitly selected the unit to be removed.

In an embodiment, the rebalancing pre-work function of the VNF may decode the internal event as ‘forceful’ VNFC instance removal on management request. Thus it will only perform readiness control 614 for the rebalancing pre-work completion condition, which means no condition for cancelling the VNFC contraction is tested. The pre-work is performed by gracefully rebalancing all VNFC instance workload to the other in service VNFC instances.

When the pre-work completion condition is met the VNF creates an OUTPUT EVENT (3) 616 to VNFM for requesting selected VNFC instance removal.

The VNFM processes 618 the VNF's request. The analysis function of VNF; decodes the EVENT (3) as a request for VNFC scale-in. The proposal function of VNFM may issue a proposal for user manual acceptance. The acceptance function may receive ACK from user. These two steps are optional. The Decision function validates VNFC instance removal as requested if conflicting requests are not in progress. The Execution function proceeds with VNFC scale-in and creates a message for removing the VNFC instance(s) from the VNF configuration.

The VNFM sends an INPUT EVENT (4) 620 to VNF for removal of the selected VNFC instance(s). This completes the workflow on VNF behalf. VNFM may additionally acknowledge 622 the completion of scale-in also to the management request initiator with error code indicating the success status.

FIG. 6B illustrates an example of VNFC capacity increase in connection with the scaling on management request. Steps 602 to 606 are the same as in the previous example.

Again, the scaling is initiated by the network operator, NFVO or element management 600. The management issues a scaling request 602 to VNFM 304.

Monitoring function 604 of VNFM is configured to decode the management request and forward 604 it to VNF is as an INPUT EVENT (2) encoded as VNFC pool size update. The message comprises the new amount of pool size as an information element.

In another example embodiment, the scaling request 602 is transmitted by the network operator, NFVO or element management 600 directly to the VNF.

The VNF receives the message and the monitoring and analysis function 606 of the VNF decodes the VNFC pool update and forwards it as an INTERNAL EVENT to scaling resolution function 630 of the VNF. The scaling resolution function resolves the new pool size by comparing the new amount with the current amount of VNFCs. In this example, the VNF scaling resolution function results to VNFC capacity expansion. Thus the VNF creates an OUTPUT EVENT (3) 616 to the VNFM for requesting VNFC instance addition.

The VNFM processes 636 the VNF's request. The analysis function of VNF decodes the EVENT (3) as a request for VNFC scale-out. The proposal function of VNFM may issue a proposal for user manual acceptance. The acceptance function may receive ACK from user. These two steps are optional. The Decision function validates VNFC instance addition as requested if conflicting requests are not in progress. The Execution function proceeds with VNFC scale-out and creates a message for adding the VNFC instance(s) to the VNF configuration.

The VNFM is configured to create and send INPUT EVENT (4) 638 to VNF for deploying a new VNFC instance. In an embodiment, the VNFM may additionally acknowledge 644 the completion of scale-out also to the management request initiator with error code indicating the success status.

The rebalancing post-work function 640 then performs readiness control 642 for the rebalancing load between the VNFC instances. This completes the workflow on VNF behalf.

FIG. 6C illustrates an example of VNFC capacity contraction in connection with the on-demand scaling.

In this case, the scaling is initiated by the VNF itself. The monitoring and analysis function 650 of the VNF detects the crossing of rebalancing pre-work start threshold or the crossing of a MIN target utilization that is set by the network operator for triggering the start of scale-in. Consequently an INTERNAL EVENT is forwarded to scaling resolution function 652 of the VNF. The scaling resolution function results in this case to a VNFC removal.

VNFC selector function 654 is triggered when scaling resolution function encodes an INTERNAL EVENT to VNFC selector for VNFC instance removal. The VNFC selector function makes decision which individual VNFC at a time provides most favourable conditions for being the subject of removal. Once the VNFC is selected a notification of the selected VNFC instance is forwarded as INTERNAL EVENT to rebalancing pre-work function 656. The pre-work has been described in more detailed above.

The rebalancing pre-work function is configured to decode the internal event as VNFC instance removal on VNF's own initiation. Readiness control 658 is performed for both for the rebalancing pre-work completion condition and the crossing of MIN target utilization. The order of readiness for the two conditions has no relevance since both conditions need to be met with the intelligent scaling. The pre-work is performed by gracefully rebalancing all VNFC instance workload to the other in service VNFC instances.

When the pre-work completion condition and the MIN target utilization threshold crossing conditions are met the VNF creates OUTPUT EVENT (3) 660 to VNFM for requesting removal of selected VNFC instance removal.

The VNFM has processes 662 the VNF's request, in a similar manner as in FIG. 6A. When the processing is complete it will consequently create INPUT EVENT (4) 664 to the VNF for undeploying (in other words removing) the VNFC instance. This completes the workflow on VNF behalf.

FIG. 6D illustrates an example of VNFC capacity increase in connection with the on-demand scaling.

Thus, the scaling is initiated by the VNF itself. The monitoring and analysis function 650 of the VNF detects the crossing of MAX TARGET UTILISATION threshold. Consequently an INTERNAL EVENT is forwarded to scaling resolution function 652 of the VNF. The scaling resolution function resolves the new pool size by comparing the new amount with the current amount of VNFCs. The scaling resolution function results in this case to a VNFC addition.

The VNF creates an OUTPUT EVENT (3) 670 for requesting VNFC instance addition from the VNFM. The VNFM processes 672 the event as in FIG. 6B and creates INPUT EVENT (4) 674 to the VNF for deploying new VNFC instance.

The rebalancing post-work function 676 of the VNF starts gracefully rebalancing existing load from in-service VNFC instances and new offered workload to the newly added VNFC instance. The post-work has been described above.

The rebalancing post-work also performs readiness control 678 for the rebalancing completion condition. This completes the workflow on VNF behalf.

FIG. 7A illustrates an example of VNFC capacity contraction in connection with the auto-scaling.

In this case, the scaling is initiated by VNFM 304. The monitoring function 700 of the VNFM detects that Virtualization Deployment Unit scale-in condition is met and initiates VNFC removal by transmitting an INPUT EVENT (2) 702 to VNF encoded as VNFC pool size update. The message comprises the new amount of pool size as an information element.

The monitoring and analysis function 704 of the VNF is configured to decode the VNFC pool update and forward it as an INTERNAL EVENT to scaling resolution function 706 of the VNF. The scaling resolution function resolves the new pool size by comparing the new amount with the current amount of VNFCs. The result which in this case is VNFC removal is next notified to selector function of the VNF 708.

The VNFC selector function 708 is configured to make a decision which individual VNFC (or VNFCs) at a time provides most favourable conditions for being the subject of removal. When the VNFC is selected a notification of the selected VNFC instance is forwarded as INTERNAL EVENT to rebalancing pre-work function 710. The pre-work has been described in more detailed above. It may be noted that the VNFC selection phase is conditional and may be bypassed if the VNFM has itself explicitly selected the unit to be removed.

In an embodiment, the rebalancing pre-work function of the VNF may decode the internal event as ‘forceful’ VNFC instance removal on management request. Thus it will only perform readiness control 712 for the rebalancing pre-work completion condition, which means no condition for cancelling the VNFC contraction is tested. The pre-work is performed by gracefully rebalancing all VNFC instance workload to the other in service VNFC instances.

When the pre-work completion condition is met the VNF creates an OUTPUT EVENT (3) 714 to VNFM for requesting selected VNFC instance removal.

When the VNFM has processed 716 the VNF's request, in a similar manner as in FIG. 6A, it will create an INPUT EVENT (4) 718 to the VNF for undeploying (in other words removing) the VNFC instance. This completes the workflow on VNF behalf.

FIG. 7B illustrates an example of VNFC capacity increase in connection with the auto-scaling.

Also in this case, the scaling is initiated by VNFM 304. The monitoring function 700 of the VNFM detects that Virtualization Deployment Unit scale-out condition is met and initiates VNFC addition by transmitting an INPUT EVENT (2) 702 to VNF encoded as VNFC pool size update. The message comprises the new amount of pool size as an information element.

The monitoring and analysis function 704 of the VNF is configured to decode the VNFC pool update and forward it as an INTERNAL EVENT to scaling resolution function 706 of the VNF. The scaling resolution function resolves the new pool size by comparing the new amount with the current amount of VNFCs. The result which in this case is VNFC addition. Thus the VNF creates an OUTPUT EVENT (3) 720 to the VNFM for requesting

VNFC instance addition.

The VNFM processes 722 the event as in FIG. 6B and creates INPUT EVENT (4) 724 to the VNF for deploying new VNFC instance.

The rebalancing post-work function 726 of the VNF starts gracefully rebalancing existing load from in-service VNFC instances and new offered workload to the newly added VNFC instance. The post-work has been described above.

The rebalancing post-work also performs readiness control 728 for the rebalancing completion condition. This completes the workflow on VNF behalf.

As the examples of FIGS. 6A to 6D, 7A and 7B indicate, presented solution introduces a common capacity scaling framework that may be applied to scaling models defined by any ETSI or other standardization party.

The roles and tasks chosen for VNFM and VNF simplify the management of VNF capacity scaling on VNFM behalf and fully exploit the natively possessed offered workload control and resource utilization control capabilities of complex VNFs. The presented pre-work and post-work functionalities in association with VNFC instance removal and addition operations enable graceful and KPI preserving VNF capacity scaling. The proposed INPUT EVENT and OUTPUT EVENT communication allows implementing precise readiness control by VNF itself when a particular VNFC removal is triggered.

It may be noted that the scaling associated pre-work and post-work control performed by the VNF is fully hidden from the VNFM and can be controlled independently from the VNFC pool capacity scaling. This makes scaling responsive and effect on KPI minimal. The rebalancing pre-work can be any time cancelled in case the VNF load trend suddenly changes from declining to ascending or the opposite.

The proposed event-based communication model enables the scaling to be able to handle successive scaling commands without problems. A new scaling event input from management or VNF itself can redirect the course of prior started scaling by just simply overwriting the prior scaling information with a new one without any complex recalculation or VNFC instance count consistency check between VNFM and VNF

For example, assume a first scaling transaction, where current VNFC pool size is 7 and new target VNFC: pool size: 5. Assuming present scaling status VNFC pool size equals 6=>pending demand for VNFC capacity change: −1

Next comes a second scaling transaction, a redirection that overwrites and cancels the prior pending scaling. The current VNFC pool size: 6, the new target VNFC: pool size: 8. Present scaling status: VNFC pool size equals 7=>pending demand for VNFC capacity change: +1

Then comes a third scaling transaction, a redirection that overwrites and cancels the prior pending scaling (e.g operator realizes made a mistake, just regrets it or the VNF load declining trend just changes to ascending). Current VNFC pool size: 7, new target VNFC: pool size: 7. Scaling status: VNFC pool size equals: 7=>pending demand for VNFC capacity change: 0. If on-demand scaling is used, the VNF would not need to issue scaling request to VNFM at all.

All this can be carried out by issuing consecutive scaling transaction commands even back-to-back from the VNFM or the VNF internally or from both without causing any confusion to the VNFM or the VNF.

With any scaling model, the actual trigger for scale-out and scale-in of VNFC instances for the VNFM comes from the VNF (OUTPUT EVENT (3)). The VNFM simply need to monitor ‘scaling flag’ set by VNF for a particular VNFC instance type and identity, indicating the count of VNFC instances subject of scaling (add/removal) by their identity. In case free selection of VNFC instance identities for scaling is supported by Virtualised infrastructure manager (VIM), the VNF, when performing pre-work for scale-in, may selectively choose the VNFC instances that are most favourable candidates for scale-in e.g. because not presently serving emergency calls or otherwise having favourable service distribution or simply because the VNFC instances are separated from active service by VNF application own fault management.

The proposed solution makes scaling control transparent and future proof by keeping the interface and information model between VNFM and VNF unchanged.

The proposed solution is particularly suitable for on-demand scaling model where VNF acts as the initiator for its own capacity scaling. The on-demand scaling capacity contraction with pre-work functionality performed by the VNF automatically validates the feasibility of the capacity contraction before it's actually been executed. This ensures that the VNFC removal itself won't immediately trigger consequent reversed capacity scaling (addition of VNFCs).

However, the proposed solution is not limited to on-demand scaling. It allows handling, prioritizing and resolving multiple simultaneous but conflicting VNF capacity scaling operations from different initiators.

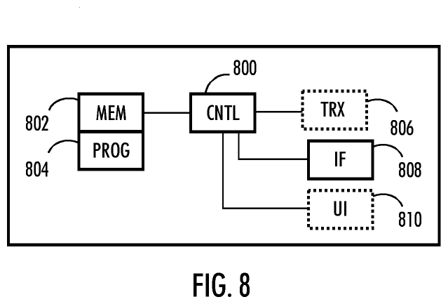

FIG. 8 illustrates an example of an apparatus of an embodiment. The apparatus may be a VNF or VNFM, for example.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities. The apparatus may be a combination of more than one similar or partly similar apparatuses described here.

The apparatus of the example includes a control circuitry 800 configured to control at least part of the operation of the apparatus.

The apparatus may comprise a memory 802 for storing data. Furthermore, the memory may store software 804 executable by the control circuitry 800. The memory may be integrated in the control circuitry.

The software 804 may comprise a computer program comprising program code means adapted to cause the control circuitry 800 of the apparatus to perform the embodiments described above.

In an embodiment, the apparatus may comprise a set 806 of transceivers. The transceiver set 806 is operationally connected to the control circuitry 800. It is connected to an antenna arrangement (not shown) that may comprise one or more antennas. The set of transceivers may comprise one or more transceivers configured to communicate with different communication systems, such as UMTS, GSM, LTE, LTE-A, TETRA, EVDO, WLAN (WiFi), to name a few.

In an embodiment, the apparatus may further comprise interface circuitry 808 configured to connect the apparatus to other devices. The interface may provide a wired or wireless connection with other devices.

In an embodiment, the apparatus may further comprise user interface 810 operationally connected to the control circuitry 800. The user interface may comprise a display, a keyboard or keypad, and a speaker, for example.

In an embodiment, the apparatus 800 may be or be comprised in a network device, such as a network node or access point, for example. The apparatus 112, 122, 102, for example. In an embodiment, the apparatus 800 is comprised in the network element 102 or in some other network element. Further, the apparatus 700 may be the network element performing the steps of FIG. 4, for example.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of circuitry' applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, at least some of the processes described in connection with FIGS. 1 to 7B may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments of FIGS. 1 to 7B or operations thereof.

According to yet another embodiment, the apparatus carrying out the embodiments comprises a circuitry including at least one processor and at least one memory including computer program code. When activated, the circuitry causes the apparatus to perform at least some of the functionalities according to any one of the embodiments of FIGS. 1 to 7B, or operations there-of.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation may be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it may be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. Embodiments of the methods described in connection with FIGS. 1 to 6 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium, for example. Coding of software for carrying out the embodiments as shown and described is well within the scope of a person of ordinary skill in the art. In an embodiment, a computer-readable medium comprises said computer program.

Even though the invention has been described above with reference to an example according to the accompanying drawings, it is clear that the invention is not restricted thereto but may be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept may be implemented in various ways. Further, it is clear to a person skilled in the art that the described embodiments may, but are not required to, be combined with other embodiments in various ways.

1-17. (canceled)

18. A method for scaling virtual network function (VNF) components, the method comprising:
determining that a capacity of VNF components is to be modified, the VNF components being related to a VNF;
in case of decreasing the capacity, selecting one or more of the VNF components for removal and causing relocation or rebalancing of a load of the selected one or more of the VNF components to a remainder of the VNF components and requesting removal of the selected one or more of the VNF components; and
in case of increasing the capacity, determining additional one or more VNF components to be deployed, requesting the additional one or more VNF components, and after receiving a command to deploy the additional one or more VNF components, causing rebalancing of a load of the VNF between the VNF components and the additional one or more VNF components.

19. A method according to claim 18, wherein the determining comprises receiving a message comprising a request to modify capacity of the VNF by changing a number of the VNF components.

20. A method according to claim 18, further comprising:
initiating rebalancing of the load of the selected one or more of the VNF components to the remainder of the VNF components in response to the load decreasing below a first predetermined threshold; and
requesting removal of the selected one or more of the VNF components in response to the load crossing a second predetermined threshold.

21. A method according to claim 20, further comprising:
interrupting the rebalancing and removal of the selected one or more of the VNF components in response to the load increasing above a third predetermined threshold that is higher than the first predetermined threshold.

22. A method according to claim 20, wherein the determining comprises monitoring the load of the VNF and observing that the load increases above a fourth predetermined threshold that is higher than the first predetermined threshold.

23. The method of claim 22, wherein deploying the additional one or more VNF components further comprises deploying the additional one or more VNF components in response to the load increasing above the fourth predetermined threshold.

24. An apparatus of a network infrastructure, comprising
at least one processor, and
at least one memory comprising a computer program code, wherein the at least one memory and the computer program code are configured, with the at least one processor, to cause the apparatus to perform operations comprising:
determine that a capacity of virtual network function (VNF) components is to be modified, the VNF components being related to a VNF;
in case of decreasing the capacity, select the one or more of the VNF components for removal and cause relocation or rebalancing of a load of the selected one or more of the VNF components to a remainder of the VNF components and re-quest removal of the selected one or more of the VNF components; and
in case of increasing the capacity, determine additional one or more of VNF components to be deployed, request the additional one or more VNF components, and after receiving a command to deploy the additional one or more VNF components cause rebalancing of a load of the VNF between the VNF components and the additional one or more VNF components.

25. The apparatus of claim 24, the at least one memory and the computer program code configured to, with the at least one processor, cause the apparatus further to perform:
receive a message comprising a request to modify the capacity of the VNF by changing a number of the VNF components.

26. The apparatus of claim 24, the at least one memory and the computer program code configured to, with the at least one processor, cause the apparatus further to perform:
initiate rebalancing of the load of the selected one or more of the VNF components to the remainder of the VNF components in response to the load decreasing below a first predetermined threshold; and
request removal of the selected one or more of the VNF components in response to the load crossing a second predetermined threshold.

27. The apparatus of claim 26, the at least one memory and the computer program code configured to, with the at least one processor, cause the apparatus further to perform:
interrupt the rebalancing and removal of the selected one or more of the VNF components in response to the load increasing above a third predetermined threshold that is higher than the first predetermined threshold.

28. The apparatus of claim 24, the at least one memory and the computer program code configured to, with the at least one processor, cause the apparatus further to perform:
monitor the load of the VNF and observing that the load increases above a fourth predetermined threshold.

29. The apparatus of claim 28, the at least one memory and the computer program code configured to, with the at least one processor, cause the apparatus further to perform:
deploy the additional one or more VNF components in response to the load increasing above the fourth predetermined threshold.

30. An apparatus of a network infrastructure, comprising
at least one processor, and
at least one memory comprising a computer program code, wherein the at least one memory and the computer program code are configured, with the at least one processor, to cause the apparatus to perform operations comprising:
determine that a capacity of a virtual network function (VNF) is to be modified;
transmit an update request to the VNF, the request comprising an amount of capacity;
receive a request from the VNF, the request comprising information on VNF components the VNF requests to be created or removed; and
transmit a command to the VNF to deploy or remove the VNF components.

31. The apparatus of claim 30, the at least one memory and the computer program code configured to, with the at least one processor, cause the apparatus further to perform:
receive from a network element a message comprising a request to modify the capacity of the VNF.

32. The apparatus of claim 30, the at least one memory and the computer program code configured to, with the at least one processor, cause the apparatus further to perform:
monitor the operation of the VNF and determining the need for modifying the capacity of a the VNF based on the monitoring of the operation of the VNF.
